(19) United States
(12) Patent Application Publication
(10) Pub. No.: US 2010/0165315 A1
(43) Pub. Date: Jul. 1, 2010

(54) EXPOSURE APPARATUS AND DEVICE MANUFACTURING METHOD

(75) Inventor: Hiroshi Tanaka, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/642,689

(22) Filed: Dec. 18, 2009

(30) Foreign Application Priority Data
Dec. 25, 2008 (JP) 2008-331185

(51) Int. Cl. G03B 27/54

(52) U.S. Cl. 355/67

(57) ABSTRACT

An apparatus which performs, using light supplied from a light source, an exposure process of transferring a pattern of an original onto a substrate by exposure and a measurement process for alignment between the original and the substrate, comprises a controller configured to control the light source, wherein the light source has an oscillation frequency that varies and is a number of times of light emission per unit time, and includes a control system configured to control a spectrum width of the light, and the controller oscillates the light source at a first oscillation frequency by setting the control system to an inactive state in the measurement process, and oscillates the light source at a second oscillation frequency by setting the control system to an active state in the exposure process.

### BACKGROUND OF THE INVENTION

1. Field of the Invention

The present invention relates to an exposure apparatus and a device manufacturing method and, more particularly, to an exposure apparatus which performs an exposure process and a measurement process using light supplied from a light source, and a method of manufacturing a device using the exposure apparatus.

2. Description of the Related Art

In recent years, to improve the resolution of an exposure apparatus employed to manufacture devices such as a semiconductor device, the wavelength of exposure light is shortening. KrF and ArF excimer lasers that typify gas lasers are the current mainstream light sources which generate exposure light beams.

An excimer laser selectively oscillates only light having specific wavelengths by a narrow-band module. Japanese Patent Laid-Open No. 2006-024855 describes the mechanism of stabilizing the spectrum width by changing the wavefront correction characteristic of a wavefront correction device in the narrow-band module.

In a conventional exposure apparatus, light generated by an excimer laser is used for both an exposure process of projecting the pattern of an original onto a substrate by a projection optical system to expose the substrate, and a measurement process for alignment between the original and the substrate in the exposure process, using light supplied from a light source. In the measurement process, the position of a substrate stage in, for example, the X, Y, and Z directions can be measured. Note that the Z direction is parallel to the optical axis of the projection optical system, and the X and Y directions are orthogonal to each other in a plane perpendicular to the optical axis.

Since an excimer laser is a gas laser, the gas inside a chamber is exchanged periodically. The gas exchange may fluctuate the composition ratio of the gas inside the gas chamber, and, in turn, change the spectrum width of the generated light. In addition, the characteristics of optical components present in the narrow-band module also often change with time. This again accounts for a change in spectrum width.

Furthermore, an excimer laser has a function of ideally maintaining the spectrum width of light constant, as described above, but the spectrum width may change depending on the oscillation frequency (the number of times of light emission per unit time), as illustrated in FIG. 2. Japanese Patent Laid-Open No. 2004-288874 points out this issue as well. This patent reference describes the fact that factors associated with the oscillation frequency adversely affect acoustic waves, resulting in a change in spectrum width.

As described above, the spectrum width of light generated by an excimer laser used as a light source of an exposure apparatus often changes due to various factors, and this often adversely affects the pattern transfer performance of the exposure apparatus. More specifically, a change in spectrum width results in a change in contrast of a pattern to be transferred. A change in contrast not only lowers the contrast of the pattern to be transferred but also deforms the pattern transferred onto a substrate because the degree of adverse influence of that change differs among individual pattern elements to be transferred.

The technique described in Japanese Patent Laid-Open No. 2006-024855 can adjust, by the wavefront correction device in the narrow-band module, the spectrum width which changes depending on the oscillation frequency of the excimer laser.

However, the exposure apparatus may use different laser oscillation frequencies for the exposure process and the measurement process. For example, to complete the measurement process in a short period of time, it is beneficial to oscillate the excimer laser at its maximum oscillation frequency. Alternatively, an oscillation frequency optimized for the measurement process may exist. In contrast, an appropriate exposure dose in the exposure process depends on, e.g., the resist sensitivity. For this reason, the exposure process often uses an oscillation frequency lower than the maximum oscillation frequency of the excimer laser. In this manner, when the exposure apparatus uses two oscillation frequencies, it can perform adjustment to stabilize the spectrum width every time the oscillation frequency is changed. This adjustment includes a process of adjusting the optical components built in the narrow-band module, and therefore requires a time expected to be appropriate.

FIG. 5 is a flowchart showing an example of a series of processes associated with wafer exposure in an exposure apparatus and spectrum width control. The exposure apparatus generally performs these processes for each lot including a plurality of wafers. A measurement process including steps S202 to S205 and an exposure process including steps S206 to S210 are sequentially performed for each wafer.

In step S201, one wafer is loaded into the exposure apparatus and mounted on the chuck of a wafer stage. In step S202, the wafer stage is positioned at the mark measurement position in order to observe a mark on the wafer stage via a reticle (original) and a projection optical system.

In step S203, the oscillation frequency of an excimer laser (light source) is set to a first oscillation frequency in preparation for the measurement process. In step S204, a process of stabilizing the spectrum width of light generated by the excimer laser is performed. This stabilization takes a time expected to be appropriate for positioning optical members built in the excimer laser by an actuator.

In step S205, the excimer laser is oscillated at the first oscillation frequency, and measurement is performed using light supplied from the excimer laser. In this measurement, information for alignment between the reticle and the wafer in the exposure process is acquired. The wafer is positioned based on the acquired information in the exposure process.

In step S206, the wafer stage is driven to the first exposure position. In step S207, the oscillation frequency of the excimer laser is set to a second oscillation frequency different from the first oscillation frequency in preparation for the exposure process. In step S208, a process of stabilizing the spectrum width of light generated by the excimer laser is performed. This stabilization takes a time expected to be appropriate for positioning the optical members built in the excimer laser by the actuator.

In step S209, the excimer laser is oscillated and one shot region on the wafer is exposed using light supplied from the excimer laser. In step S210, it is determined whether an unexposed shot region is present. If an unexposed shot region is present, the process returns to step S209, in which the unexposed shot region is exposed as the exposure target. Prior to this exposure, the wafer stage is driven in accordance with the position of the exposure target shot region.

In step S211, it is determined whether an unprocessed wafer is present. If an unprocessed wafer is present, the process returns to step S201, and the processes in steps S201 to S210 are performed for the new wafer.

### SUMMARY OF THE INVENTION

One of the aspects of the present invention provides an apparatus which performs, using light supplied from a light source, an exposure process of transferring a pattern of an original onto a substrate by exposure, and a measurement process for alignment between the original and the substrate, the apparatus comprising a controller configured to control the light source, wherein the light source has an oscillation frequency that varies and is a number of times of light emission per unit time, and includes a control system configured to control a spectrum width of the light, and the controller oscillates the light source at a first oscillation frequency by setting the control system to an inactive state in the measurement process, and oscillates the light source at a second oscillation frequency by setting the control system to an active state in the exposure process.

Further features of the present invention will become apparent from the following description of exemplary embodiments with reference to the attached drawings.

### BRIEF DESCRIPTION OF THE DRAWINGS

FIG. 1 is a block diagram showing the schematic arrangement of an exposure apparatus according to an embodiment of the present invention;

FIG. 2 is a graph illustrating a change in spectrum width of an excimer laser;

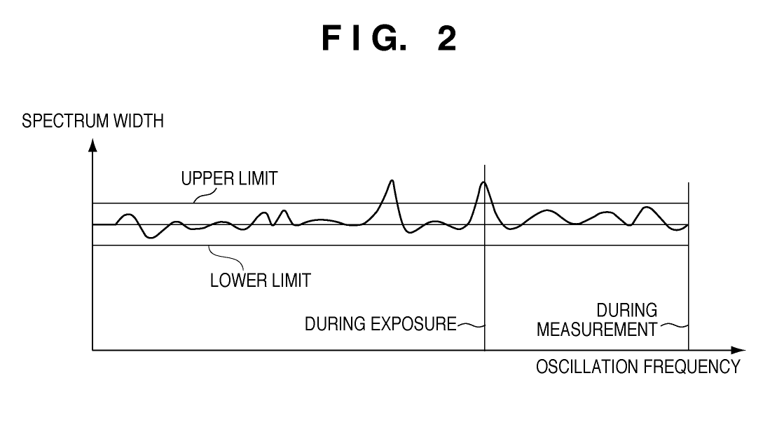

FIG. 3 is a flowchart showing the operation of the exposure apparatus according to the embodiment of the present invention;

FIG. 4 is a timing chart showing the operation of the exposure apparatus according to the embodiment of the present invention;

FIG. 5 is a flowchart showing an example of a series of processes associated with wafer exposure in an exposure apparatus and spectrum width control; and

FIG. 6 is a block diagram schematically showing the arrangement of a spectrum width adjusting module.

### DESCRIPTION OF THE EMBODIMENTS

Various embodiments of the present invention will be described below with reference to the accompanying drawings.

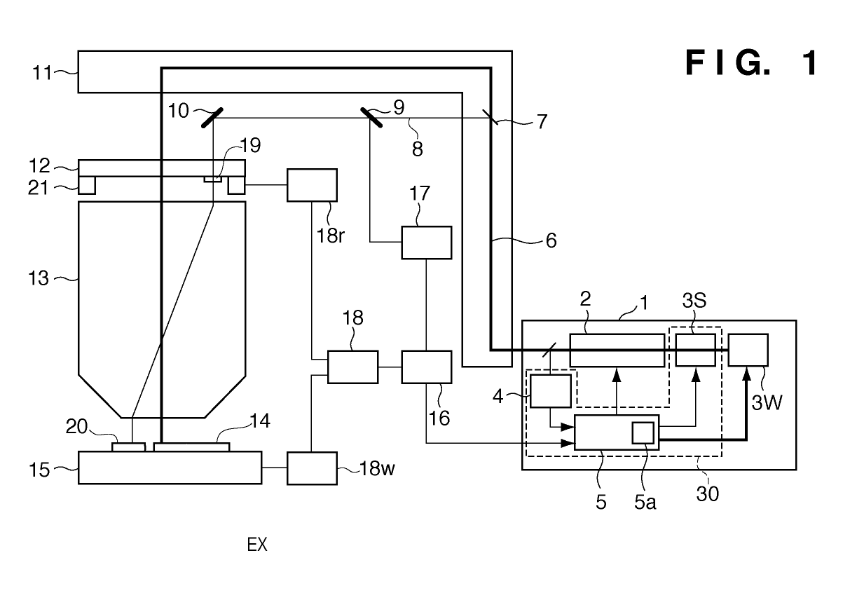

FIG. 1 is a block diagram showing the schematic arrangement of an exposure apparatus according to an embodiment of the present invention. This exposure apparatus may be an exposure apparatus which exposes a wafer while scanning a reticle and the wafer (i.e., a scanning exposure apparatus), or an exposure apparatus which exposes a wafer while a reticle and the wafer stand still.

An exposure apparatus EX includes a reticle stage 21 which holds a reticle (original) 12, an illumination optical system 11 which illuminates the reticle 12, a wafer stage 15 which holds a wafer (substrate) 14, and a projection optical system 13 which projects the pattern of the reticle 12 onto the wafer 14. The illumination optical system 11 illuminates the reticle 12 with light supplied from a light source 1.

The light source 1 is an excimer laser serving as a pulsed light source, and has a variable oscillation frequency. Note that the oscillation frequency is a number of times of light emission per unit time. The light source 1 includes a chamber 2, narrow-band module 3W, spectrum width adjusting module 3S, measurement device (wavelength meter) 4, and laser controller 5.

The chamber 2 is filled with a gas. The narrow-band module 3W selects components, having specific wavelengths, of light (pulsed light) output from the chamber 2, and returns the selected light components to the chamber 2, thereby spectrally narrowing light generated by the light source 1. The spectrum width adjusting module 3S adjusts the spectrum width of the spectrally narrowed light. The measurement device 4 measures the center wavelength and spectrum width of the light generated in the chamber 2. The laser controller 5 receives the information of the center wavelength and spectrum width from the measurement device 4 for each pulsed light emission. The laser controller 5 then outputs command values to the narrow-band module 3W and the spectrum width adjusting module 3S so that the center wavelength and spectrum width of the next pulsed light become the command values. In this embodiment, the measurement device 4, laser controller 5, and spectrum width adjusting module 3S constitute a spectrum width control system 30 which controls the spectrum width of light generated by the light source 1. Light (pulsed light) 6 generated by the light source 1 is supplied to the illumination optical system 11.

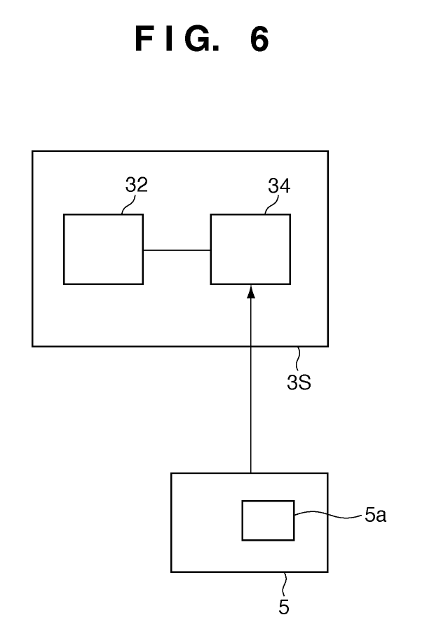

FIG. 6 is a block diagram schematically showing the arrangement of the spectrum width adjusting module 3S. The spectrum width adjusting module 3S includes an optical member 32 for controlling the spectrum width of light generated by the light source 1, and an actuator 34 for positioning the optical member 32. The laser controller 5 includes a holding unit (storage unit) 5a which stores a driving command value for the actuator 34 immediately before the stop of the operation of the spectrum width control system 30. The laser controller 5 sends the driving command value held in the holding unit 5a to the actuator 34 at the start (restart) of the operation of the spectrum width control system 30. The actuator 34 positions the optical member 32 in accordance with the sent command value. During the operation of the spectrum width control system 30, the command value held in the holding unit 5a is updated as needed by a latest command value.

Excimer laser light emission control will be briefly described: the laser controller 5 triggers a pulse generator (not shown) at the set oscillation frequency to apply a high-voltage pulse to the chamber 2. The laser controller 5 may also be configured to trigger the pulse generator in accordance with a light emission command or light emission timing signal sent from a controller 16.

A substrate process performed by the exposure apparatus EX includes an exposure process and a measurement process. The exposure process is a process of projecting the pattern of the reticle 12 onto the wafer 14 by the projection optical system 13 to expose the wafer 14, using light supplied from the light source 1. The measurement process is a process for alignment between the reticle 12 and the wafer 14 in the exposure process. The measurement process also uses light supplied from the light source 1.

The controller 16 can be configured to issue commands associated with the oscillation frequency, the energy for each pulsed light emission, and the light emission timing to the light source 1 in the exposure process and the measurement process. Note that the oscillation frequency is the number of times of light emission per unit time (typically, the number of times of light emission per sec).

In the exposure process, the positions of the reticle stage 21 and wafer stage 15 are controlled by a stage controller 18 while being measured by interferometers 18r and 18w. When the exposure apparatus EX serves as a scanning exposure apparatus, the stage controller 18 synchronously operates the reticle stage 21 and the wafer stage 15 in exposure of each shot region on the wafer 14.

In the measurement process, the relative position between the reticle 12 or reticle stage 21 and the wafer stage 15 is measured, and that between the wafer stage 15 and the wafer 14 is also measured using a wafer microscope (not shown). These measurements allow determination of the relative position between the wafer 14 and the reticle 12.

A process (calibration measurement) of measuring the relative position between the reticle 12 and the wafer stage 15 will be explained. A certain component 8 of light supplied from the light source 1 is split by a mirror 7 and illuminates a mark 19 on the reticle 12 via mirrors 9 and 10. Note that a mark on the reticle stage 21 is illuminated in measuring the relative position between the reticle stage 21 and the wafer stage 15.

The light reflected by the mark 19 forms an image of the mark 19 on the image sensing surface of an image sensor 17 via the mirror 9. On the other hand, the light having passed through the mark 19 illuminates a mark 20 located on the wafer stage 15 via the projection optical system 13. The light reflected by the mark 20 retraces its optical path in the projection optical system 13, is transmitted through the mark 19, and forms an image of the mark 20 on the image sensing surface of the image sensor 17 via the mirror 9. Hence, the image sensor 17 senses the images of the marks 19 and 20. With this operation, the relative position between the reticle 12 and the wafer stage 15 is detected.

The foregoing description is concerned with a relative position measurement method of an image processing scheme. Instead of this method, another scheme may be adopted. In this scheme, slits are respectively formed in the mark 19 on the reticle 12 and in the mark 20 on the wafer stage 15, and the light beams having passed through these slits are detected by a photoelectric conversion element located on the wafer stage 15.

Control of the light source 1 will be explained next. The controller 16 can be configured to set the center wavelength and the spectrum width for the laser controller 5 of the light source 1 by sending a center wavelength command value and a spectrum width command value to the laser controller 5, and send a light emission command to the laser controller 5. The center wavelength and the spectrum width may also be set for the light source 1 in advance.

Upon reception of the center wavelength command value and the spectrum width command value, the laser controller 5 outputs a driving command value to the narrow-band module 3W to set the wavelengths used, and outputs a driving command value to the spectrum width adjusting module 3S to set the spectrum width used. At this time, the driving command value held in the holding unit 5a is used as the initial value of the driving command value to be sent to the spectrum width adjusting module 3S.

Upon reception of the light emission command from the controller 16, the laser controller 5 triggers a pulse generator (not shown) at the timing corresponding to the set oscillation frequency. In accordance with this trigger, the pulse generator applies a high-voltage pulse to the chamber 2. Accordingly, laser oscillation takes place and so pulsed light is output.

The laser controller 5 determines the driving command value for each pulsed light emission so as to reduce a deviation of the center wavelength measured by the measurement device 4 with respect to the center wavelength command value, and sends the determined value to the narrow-band module 3W. Also, the laser controller 5 determines the driving command value for each pulsed light emission so as to reduce a deviation of the spectrum width measured by the measurement device 4 with respect to the spectrum width command value, and sends the determined value to the spectrum width adjusting module 3S. This stabilizes the spectrum so that the center wavelength and spectrum width of pulsed light emitted next become equal to the center wavelength command value and spectrum width command value, respectively.

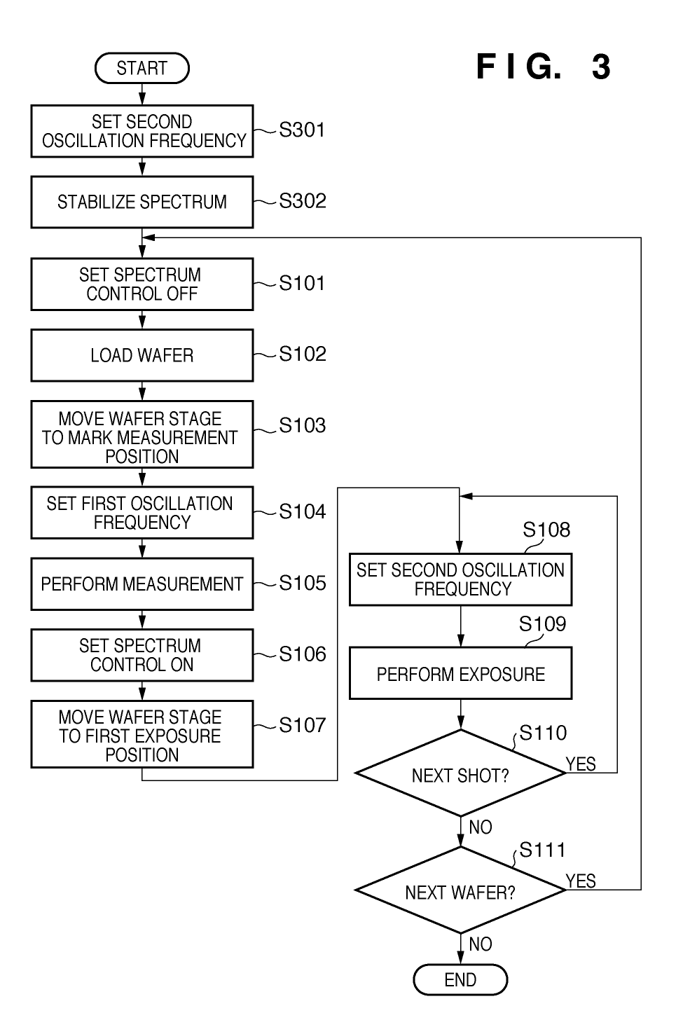

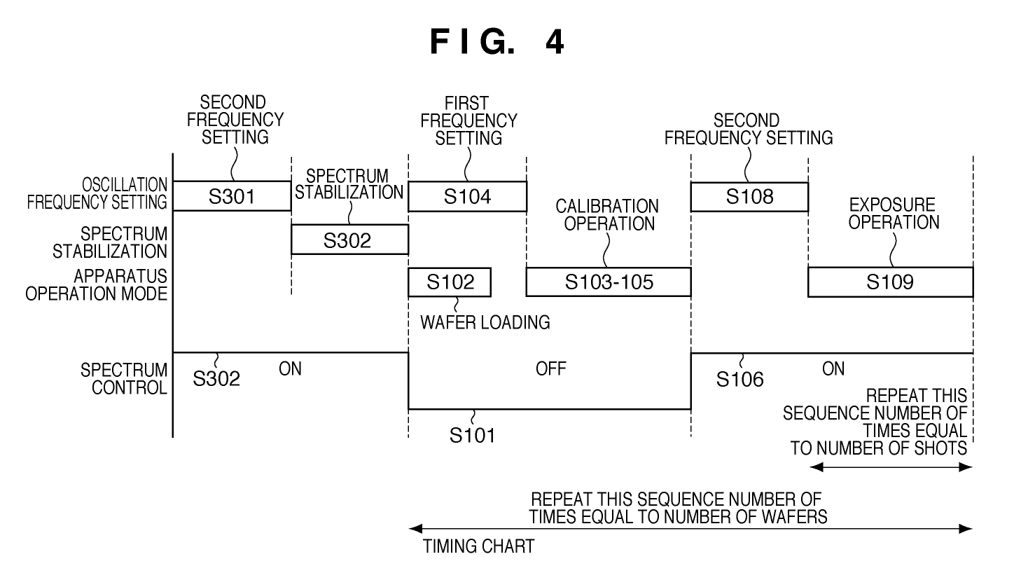

FIGS. 3 and 4 are a flowchart and a timing chart, respectively, showing the operation of the exposure apparatus EX according to the embodiment of the present invention. The controller 16 controls this operation.

The oscillation frequency of light for use in the exposure process is calculated in accordance with the target exposure dose and the stage scanning speed and determined as a second oscillation frequency. On the other hand, the oscillation frequency of light for use in the measurement process (calibration) is determined as a first oscillation frequency. The first oscillation frequency and the second oscillation frequency are different because it is beneficial to perform the measurement process in the shortest period of time from the viewpoint of ensuring a given throughput. The first oscillation frequency for use in the measurement process can be the maximum oscillation frequency of the light source 1, whereas the second oscillation frequency for use in the exposure process is not often the maximum oscillation frequency.

To process a lot including a plurality of wafers, before processing the first wafer in the lot, the spectrum width control system 30 is set to an active state to oscillate the light source 1 at the second oscillation frequency, thereby stabilizing the spectrum width of light generated by the light source 1.

More specifically, the controller 16 sets the second oscillation frequency for the light source 1 in step S301, and the spectrum width control system 30 is set to an active state to oscillate the light source 1, thereby stabilizing the spectrum width of light generated by the light source 1 in step S302. As described above, during the operation of the spectrum width control system 30, the command value held in the holding unit 5a is updated as needed by a latest command value. Note that in this embodiment, the narrow-band module 3W is set to an active state during light emission to control the center wavelength to a constant value.

After the spectrum width is stabilized, a measurement process including steps S101 to S105 and an exposure process including steps S106 to S110 are sequentially performed for each wafer.

In step S101, the controller 16 sets the spectrum width control system 30 to an inactive state (OFF state). In this state, the holding unit 5a holds the latest command value updated in the operation of the spectrum width control system 30.

Control of the spectrum width of light generated by the light source 1 is important for the exposure process but is unimportant for the measurement process (calibration). For this reason, in this embodiment, the spectrum width control system 30 is set to an inactive state (OFF state) in the measurement process. In contrast to this, the center wavelength of light generated by the light source 1 in the measurement process influences the pattern transfer magnification and focus of the reticle 12, so it is precisely controlled even in the measurement process.

In step S102, a wafer is loaded and mounted on the chuck of the wafer stage 15. In step S103, the wafer stage 15 is positioned at the mark measurement position in order to observe the mark 20 on the wafer stage 15 via the reticle 12 and projection optical system 13.

In step S104, the controller 16 sets the oscillation frequency of the light source 1 to a first oscillation frequency in preparation for the measurement process. Note that steps S101 to S103 are performed in arbitrary order.

In step S105, the light source 1 is oscillated and measurement is performed using light supplied from the light source 1. In this measurement, information for alignment between the reticle and the wafer in the exposure process is acquired. The wafer is positioned based on the acquired information in the exposure process.

After the measurement process (calibration) is ended, the controller 16 sets the spectrum width control system 30 to an active state (ON state) in step S106. In the process of a shift of the spectrum width control system 30 from an inactive state to an active state, the driving command value held in the holding unit 5a is issued to the actuator 34 of the spectrum width control system 30 as the initial value. The driving command value held in the holding unit 5a is that for the actuator 34 to obtain a stabilized spectrum width at the second oscillation frequency.

In step S107, the wafer stage 15 is driven to the first exposure position. In step S108, the controller 16 sets the oscillation frequency of the light source 1 to a second oscillation frequency different from the first oscillation frequency in preparation for the exposure process.

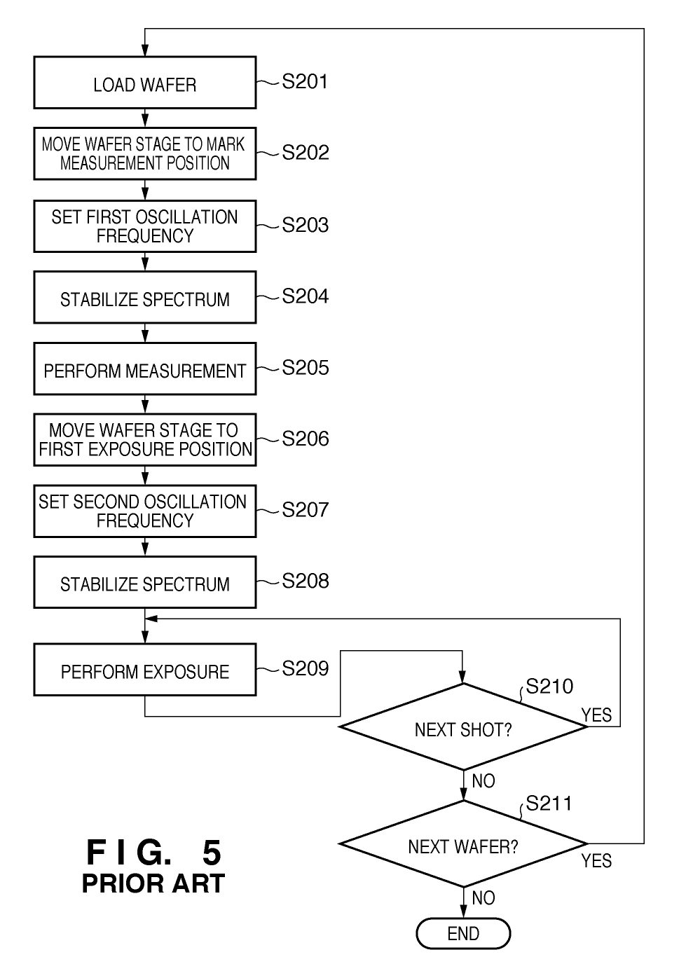

In step S109, the light source 1 is oscillated and one shot region on the wafer is exposed using light supplied from the light source 1. At this time, the light source 1 is oscillated at the second oscillation frequency, and the command value held in the holding unit 5a as mentioned above is used as a driving command value for spectrum width control. Hence, a stabilized spectrum width is obtained from the beginning of oscillation. This reduces the time to stabilize the spectrum width as in step S208 of FIG. 5.

In step S110, it is determined whether an unexposed shot region is present. If an unexposed shot region is present, the process returns to step S108, and the processes in steps S108 to S110 are performed for the next shot region. If an unexposed shot region is not present, step S111 is performed. In step S111, it is determined whether an unprocessed wafer is present. If an unprocessed wafer is present, the process returns to step S101, and the processes in steps S101 to S111 are performed for the new wafer.

As has been described above, according to the embodiment of the present invention, the time consumed to stabilize the spectrum width of light generated by the light source 1 in the exposure process is reduced. This shortens the total time consumed for a process of each wafer, thus improving the throughput.

The above-mentioned embodiment is concerned with the mechanism of setting a spectrum width control system to an inactive state in a measurement process, and setting it to an active state in an exposure process, thereby reducing the time consumed to stabilize the spectrum width. Such an idea is also applicable to the mechanism of reducing the time consumed to stabilize, for example, the energy of light generated by the light source 1.

A method of manufacturing devices (e.g., a semiconductor device and a liquid crystal display device) according to one embodiment of the present invention will be explained next.

A semiconductor device is manufactured by a preprocess of forming an integrated circuit on a wafer (semiconductor substrate), and a post-process of completing, as a product, a chip of the integrated circuit formed on the wafer by the preprocess. The preprocess can include a step of exposing a wafer coated with a photosensitive agent using the above-mentioned exposure apparatus, and a step of developing the wafer. The post-process can include an assembly step (dicing and bonding) and packaging step (encapsulation). Also, a liquid crystal display device is manufactured by a step of forming a transparent electrode. The step of forming a transparent electrode can include a step of coating a glass substrate, on which a transparent conductive film is deposited, with a photosensitive agent, a step of exposing the glass substrate coated with the photosensitive agent using the above-mentioned exposure apparatus, and a step of developing the glass substrate.

The device manufacturing method according to this embodiment is more beneficial to at least one of the productivity and quality of devices than the prior arts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-331185, filed Dec. 25, 2008, which is hereby incorporated by reference herein in its entirety.

What is claimed is:

1. An apparatus which performs, using light supplied from a light source, an exposure process of transferring a pattern of an original onto a substrate by exposure and a measurement process for alignment between the original and the substrate, the apparatus comprising:
a controller configured to control the light source,
wherein the light source has an oscillation frequency that varies and is a number of times of light emission per unit time, and includes a control system configured to control a spectrum width of the light, and
the controller oscillates the light source at a first oscillation frequency by setting the control system to an inactive state in the measurement process, and oscillates the light source at a second oscillation frequency by setting the control system to an active state in the exposure process.

2. The apparatus according to claim 1, wherein
the control system includes an adjusting module including an optical member configured to control the spectrum width of the light and an actuator configured to position the optical member, and a storage unit configured to store a latest command value for the actuator on an operation of the control system, and
the actuator positions the optical member based on the stored command value when the control system starts operating.

3. The apparatus according to claim 1, wherein
to process a lot including a plurality of substrates, before processing a first substrate in the lot, the control system is set to an active state to oscillate the light source at the second oscillation frequency and stabilize a spectrum width of light generated by the light source.

4. A method comprising:
exposing a substrate using an exposure apparatus; and
developing the exposed substrate,
wherein the exposure apparatus is configured to perform, using light supplied from a light source, an exposure process of transferring a pattern of an original onto a substrate by exposure and a measurement process for alignment between the original and the substrate, and comprises:
a controller configured to control the light source,
wherein the light source has an oscillation frequency that varies and is a number of times of light emission per unit time, and includes a control system configured to control a spectrum width of the light, and
the controller oscillates the light source at a first oscillation frequency by setting the control system to an inactive state in the measurement process, and oscillates the light source at a second oscillation frequency by setting the control system to an active state in the exposure process.

5. A method comprising:
performing an exposure process and a measurement process using light supplied from a light source having an oscillation frequency that varies and is a number of times of light emission per unit time;
controlling the light source by a controller;
controlling a spectrum width of the light by a control system;
oscillating the light source at a first oscillation frequency by setting the control system to an inactive state in the measurement process; and
oscillating the light source at a second oscillation frequency by setting the control system to an active state in the exposure process.

6. The method according to claim 5, wherein performing the exposure process includes transferring a pattern of an original onto a substrate by exposure, performing the measurement process includes aligning between the original and the substrate.

7. The method according to claim 5 further comprising:
controlling the spectrum width of the light by an optical member of an adjusting module; and positioning the optical member by an actuator.

8. The method according to claim 7 further comprising:
storing a latest command value for the actuator on an operation of the control system, and
wherein the actuator positioning the optical member is based on the stored command value when the control system starts operating.

9. The method according to claim 5, further comprising:
setting the control system to an active state to oscillate the light source at the second oscillation frequency and stabilizing a spectrum width of the light before processing a first substrate in a lot.

10. The method according to claim 9, wherein the lot includes a plurality of substrates.
